(19) United States
(12) Patent Application Publication
(10) Pub. No.: US 2006/0150411 A1
(43) Pub. Date: Jul. 13, 2006

(54) Method for production of a mining metal plug

(75) Inventor: Wolfgang Welser, Wohnsitz (AT)

Correspondence Address: VENABLE LLP, P.O. BOX 34385, WASHINGTON, DC, 20045-9998, US

(73) Assignee: WELSER PROFILE AG, Ybbsitz (AT)

(21) Appl. No.: 10/512,769

(22) PCT Filed: Apr. 24, 2003
(86) PCT No.: PCT/EP03/04279

§ 371 Date: Jun. 21, 2005

(30) Foreign Application Priority Data
May 29, 2002 (DE) 102 19 155.7

(51) Int. Cl. B23P 15/16

(52) U.S. Cl. 29/896.6

(57) ABSTRACT

The invention refers to a method for the production of a metal mining plug with grooves applied to the exterior thereof. In order to achieve an easy and simple manufacture of the metal mining plug and to achieve at the same time a long durability of the metal mining plug when being used in rock mass, a metal mining plug is formed of a flat material which is provided with grooves and which is formed to a tube by means of cold rolling.

The present invention refers to a method for the production of a mining metal plug with grooves applied to the exterior thereof according to the preamble of claim 1.

A sleeve for self-drilling plugs and a method for the production of the sleeve is known from the German laying open specification 2 103 132 A. In this laying-open specification a sleeve made of flat material is disclosed. The flat material is rolled in the state in which it is cut into lengths. The flat material and the sleeve formed thereof has jags at least at one end. In a tunnel located in a mountain, this sleeve is driven into the mountain itself. The jagged end is spread open through a cone. Thus, the sleeve conjoins with the mountain stone.

Only the jags are responsible for a good hold of the sleeve in the stone of the mountain.

Moreover, a method of reinforcing a rock formation by means of mining plugs is disclosed in US specification 38 37 258 A. This method also discloses a sleeve having a C-profile. However, the sleeve is not closed. Great stress concentrations can therefore not properly be absorbed.

A rock bolt is known from the German publication DE 100 17 750 A1. A fastening element for use in mining or tunnel construction is disclosed. The fastening element has a receiving body which is provided on one end with a drilling head and which has an engagement means on the opposite end. The receiving body has a longitudinal bore in which a mortar mass is arranged. The end portion of the fastening element opposing in the setting direction comprises at least one through bore. A mixing device is arranged between the mortar mass and the through bore which mixes the individual components of the mortar mass during the setting process before exiting through the through bore.

However, the rock bolt construction is very complex. By providing the mixing device the production costs are, unfortunately, high.

An active shoring for mine support in longwall and section is known from the German specification DE 43 43 313A1. An active shoring that can be used for underground mining, which is disclosed there, consists of a hollow body whose wall totally or partially consists of sheet metal. When filling-in particularly water, the hollow body is inflated to such an extent that it may fill a cavity or also an excavation into which it was previously slid or inserted in the non-inflated condition. The individual hollow bodies are provided with coupling elements to be able to connect them with one another or with the rock mass or the finishes in a manner that they remain in the predetermined position also during the setting process. However, these inflatable hollow bodies made of sheet material are not especially durable in the rock mass. The remaining of the shoring or the metal plugs is especially decisive for the long life cycle for instance of a tunnel in which the support elements are inserted.

Furthermore, plugs made of metal for use in mining are known. The metal plugs used up to now consist of full material and are driven into the rock mass in mining after drilling a hole. These plugs take care that a gallery driven into the mountain does not collapse. By use of an additional medium, e.g. an adhesive, an additional safety against collapsing of the gallery is ensured.

In the former solutions it was required to drill a hole to subsequently insert a plug by means of an adhesion cartridge. Thus, it is not possible to insert the adhesive through the rod.

Thus, it is the object of the invention to provide a method by means of which metal mining plugs can be manufactured in a simple and inexpensive manner.

This object is solved by the features of claim 1. Further embodiments can be derived from the dependent claims.

The hole for inserting the plug does not have to be drilled in a separate working step, i.e. it may be drilled by the plug itself. The hole can also be drilled by such a plug when a drill bit is set onto the plug. In the invention, the rock mass can be excavated by suction through the plug.

It is particularly advantageous when the longitudinal sides of the flat material are welded together after forming. In this embodiment a closed tubular profile can easily be accomplished. By the fact that the tubular profile is closed, no adhesive can escape on the seam when the adhesive is pressed into the tube. Thus, a high pressure generation of the adhesive in the tube is possible.

In case the grooves have a longitudinal direction orthogonal or at an angle to the longitudinal axis of the tube, a high frictional or adhesive coefficient between the plug and the rock may result. Thus, a locking of the plug against falling and/or slipping of the plug out of the rock can be ensured in this embodiment.

In another embodiment, a special advantage can be found in the durability of the plug in the rock. In this embodiment it may particularly be advantageous if the grooves are arranged in rows parallel to the longitudinal axis of the plug.

If the grooves are arranged in rows, a simple production of the plug can be achieved in this embodiment, since the tool, which creates the grooves, must penetrate into the workpiece, the metal mining plug, if necessary.

If the grooves are arranged in a row with an identical distance to one another, the tool, on the one hand, may have a simple design, and after installation of the plug into the rock a regular power distribution results. This contributes to the saving of costs and to achieving a long durability.

It is particularly advantageous if the grooves of the one row are arranged offset in the height to the grooves of at least another row. In this embodiment an especially stable and tough adhesive layer results.

If the grooves all have the same shape, one and the same tool may be utilized for manufacturing the grooves in the metal mining plug. However, one tool only is required. However, several tools of the same type can be used to achieve short stop periods.

If all grooves have the same length, the tool used for producing the grooves is in engagement for an identically long period of time. Thus, the degree of abrasion can clearly be determined, which significantly facilitates a precise control of the stop and maintenance times for the tool.

It is particularly advantageous if the grooves have a triangular cross section, wherein the apex of the triangle directed towards the interior of the plug has a rounding. A tool designed in this manner for manufacturing the grooves can be manufactured in a particularly simple manner and is extremely durable. Thus, a minimization of the maintenance costs in the manufacture of the plug can be achieved.

The embodiments of the present invention will now be explained in more detail with reference to the drawings.

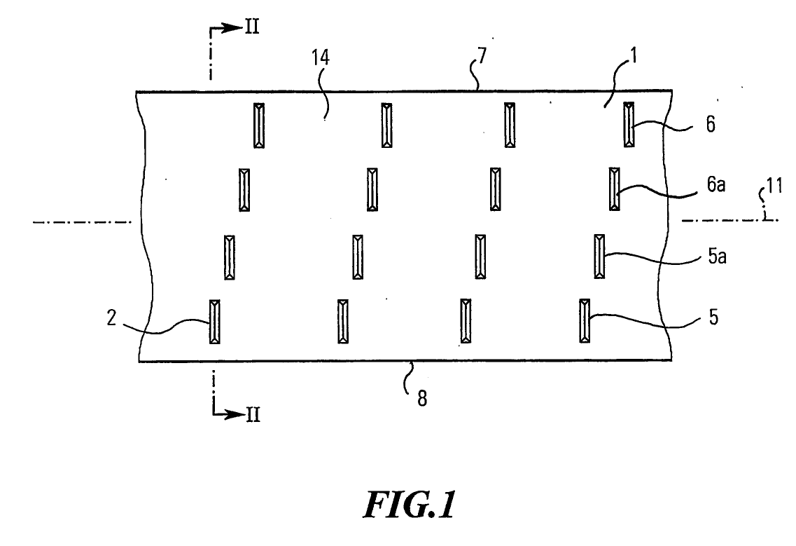

FIG. 1 shows a top plan view onto the flat material used in this method;

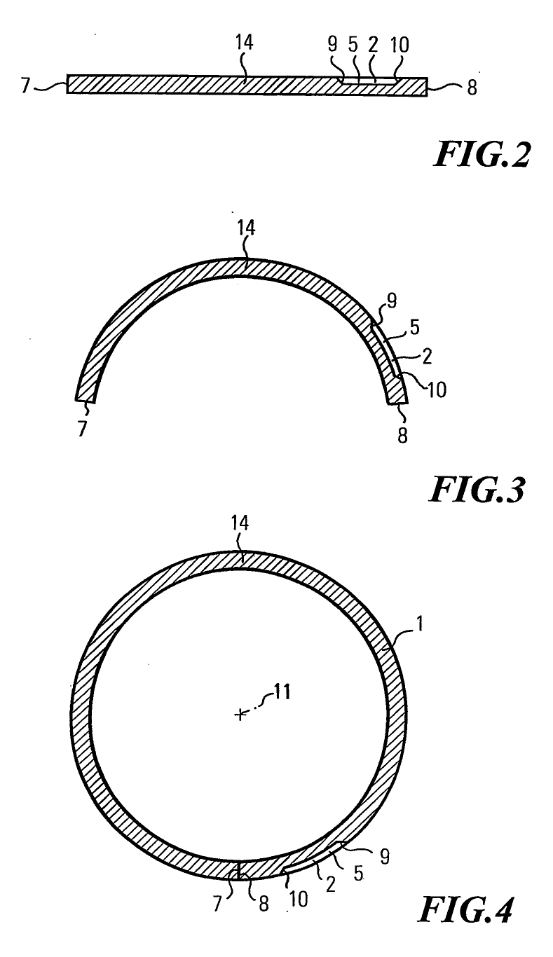

FIG. 2 shows a cross section through the flat material along line 11 of FIG. 1,

FIG. 3 shows a bending of the flat material according to the method,

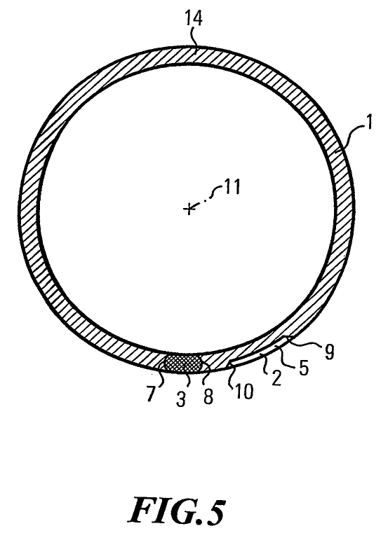

FIG. 4 shows a folding of the flat material to form a tube according to the method of obtaining a metal mining plug,

FIG. 5 shows a cross section through the material bent and welded to form a tube,

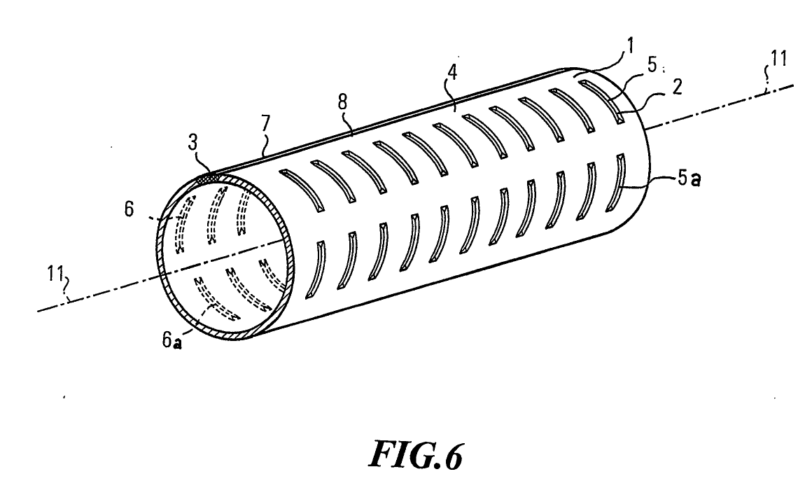

FIG. 6 shows a perspective view of the metal mining plug, and

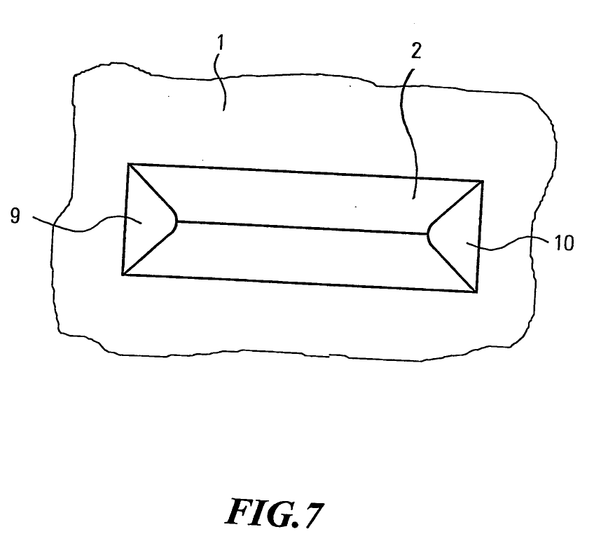

FIG. 7 shows a groove of FIG. 6 in a detailed view.

In FIG. 1 a flat material 14 can be seen. In a first processing step in this embodiment, the grooves 2 are introduced into the flat material 14. The grooves 2 are arranged in rows 5, 5a, 6 and 6a. It can be seen that the height of the grooves 2 varies in height from row to row. The height of the grooves 2 is defined parallel to the longitudinal axis 11 of the flat material 14. The shape and length of the grooves 2 are identical in all rows 5, 5a, 6 and 6a. The grooves 2 are worked into the flat material 14 by means of a tool. The flat material 14 is a metal sheet. The longitudinal sides 7 and 8 of the flat material 14 extend in parallel to the longitudinal axis 11 of the flat material 14. The grooves 2 extend transversely to the longitudinal axis 11.

FIG. 2 shows a cross section through the flat material 14 along the line 11 of FIG. 1. The flat material 14 is closed on both sides by the longitudinal sides 7 and 8 of the flat material 14. A groove 2 of the row 5 can be seen in this Figure. A flank 9 and a flank 10, which was worked into the flat material by means of a tool, can also be seen. It can also be seen that the flanks 9 and 10 have an angle to the longitudinal side 8 and 9 which amounts to a maximum of 90°.

FIG. 3 shows the next processing step by means of which the flat material 14 is bent in a manner that a rounding results and the groove 2 rests on the outer side of the flat material.

FIG. 4 shows the flat material 14 bent to form a tube after the cold rolling process. Thus, the metal mining plug is formed.

FIG. 5 shows a welding seam 3 through which the longitudinal sides 7 and 8 of the cold-formed and bent flat material 14, now in the state of a tube, are joined.

FIG. 6 shows the metal mining plug 1 with grooves 2 arranged in row 5, 5a, 6 and 6a. The metal mining plug is made from a flat material of sheet to form a tube with a round cross section. The longitudinal sides 7 and 8 are bent together such that they are connected to one another through a welding seam 3. The longitudinal axis 11 extends centrically through the centre of the metal mining plug 1.

FIG. 7 shows a groove in top plan view. The groove 2 is embedded into the metal mining plug 1. The groove 2 has a triangular cross section, wherein the apex of the triangle worked into the flat material is rounded. The groove 2 has a flank 9 and a flank 10. The flanks 9 and 10 are slightly inclined with respect to the surface of the metal mining plug 1. In a special embodiment, the flanks 9 and 10 have a right angle to the surface of the metal mining plug 1. In a special embodiment the grooves 2 have different lengths.

1. A method for producing a metal mining plug (1) with grooves (2) applied to the exterior thereof by forming a flat material (14), characterized in that a flat material (14) is provided with the grooves (2) and formed to a tube by means of cold rolling, and that the longitudinal sides of the material are welded together after the forming process.

2. A metal mining plug (1) manufactured according to the method of claim 1, characterized in that the grooves (2) have a longitudinal direction orthogonally or at an angle to the longitudinal axis (11) of the tube.

3. A metal mining plug (1) as claimed in claim 1, characterized in that the grooves (2) are arranged in rows (5, 5a, 6 and 6a) parallel to the longitudinal axis (11) of the tube.

4. A metal mining plug (1) as claimed in claim 1, characterized in that the grooves (2) are arranged in rows (5, 5a, 6 and 6a).

5. A metal mining plug (1) as claimed in claims, characterized in that the grooves (2) are arranged in a row (5, 5a, 6 or 6a) at an identical distance to one another.

6. A metal mining plug (1) as claimed in claim 1, characterized in that the grooves (2) of the one row (5, 5a, 6 or 6a) are arranged offset in the height to the grooves (2) of at least another row (5, 5a, 6 or 6a).

7. A metal mining plug (1) as claimed in claim 1, characterized in that all grooves (2) have the same shape.

8. A metal mining plug (1) as claimed in claim 1, characterized in that all grooves (2) have the same length.

9. A metal mining plug (1) as claimed in claim 1, characterized in that the grooves (2) have a triangular cross section, wherein the apex of the triangle directed into the interior of the metal mining plug is rounded.
